(19) United States
(12) Patent Application Publication
(10) Pub. No.: US 2025/0276235 A1
(43) Pub. Date: Sep. 4, 2025

(54) Electric Skateboard

(71) Applicant: Cycleagle Intelligent Equipment (Weihai) Co., Ltd., Shandong (CN)

(72) Inventor: Chengdong XU, Shandong (CN)

(73) Assignee: Cycleagle Intelligent Equipment (Weihai) Co., Ltd., Shandong (CN)

(21) Appl. No.: 18/594,158

(22) Filed: Mar. 4, 2024

(51) Int. Cl. A63C 17/12; A63C 17/01; A63C 17/26; H01M 50/284

(52) U.S. Cl. CPC A63C 17/12; A63C 17/012; A63C 17/015; A63C 17/26; A63C 2203/12; A63C 2203/14; A63C 2203/24; H01M 50/284; H01M 2220/20

(57) ABSTRACT

An electric skateboard comprises a main board body, a front axle assembly, a rear axle assembly, a buffering device, a moving device and an electric control device, wherein the electric control device is electrically connected with the front axle assembly and the rear axle assembly, the moving device supports and moves the skateboard, and the buffering mechanism is operatively connected to the main board body and the moving device, and provides buffering for the movement of the skateboard when the skateboard is in a moving state.

### TECHNICAL FIELD

The present invention relates to the technical field of skateboards, in particular to an electric skateboard.

### BACKGROUND

Skateboarding, as an extreme sport with a long history, originated in the United States in the 1950s. At first, it was just a land substitute for surfboard, aiming to make enthusiasts experience similar fun when they can't surf. However, with the passage of time, skateboarding has gradually developed into a unique and challenging sport, attracting the love of many young people around the world. Nowadays, skateboarders all over the world have combined skateboarding with other fields of art, culture, science and technology in their own way, constantly expanding the boundaries of this sport. As a new sub-field, the electric skateboard has many problems, such as motion instability at high speed, which is also called “death swing” by people in the industry. On the one hand, the body design of electric skateboard greatly affects its stability. Because the car body is light, it is easy to cause the risk of sideslip and rollover when driving at high speed. On the other hand, factors such as road conditions and wind direction during driving will also have an impact on the stability of the car body. In the complex road conditions and environment, the high-speed driving safety of electric skateboards is worrying. Therefore, how to ensure the stability and safety of electric skateboards is the direction that the industry needs to study deeply.

In the patent document with publication number of U.S. Pat. No. 20220331686A1, a skateboard suspension is introduced in detail, comprising a pair of steering knuckles on opposite sides of a chassis frame of the skateboard, a pair of upper control arms connected between the pair of steering knuckles and the chassis frame, a pair of lower control arms connected between the pair of steering knuckles and the chassis frame, and a first spring damper connected between the pair of upper control arms. This kind of skateboard has many parts such as swing arms and springs, which can ensure the comfort when driving. However, because the overall structure is too small and too thin, there are too many connection points between the parts, so there are problems such as short service life and insufficient stability.

Therefore, based on the above problems, we propose a brand-new electric skateboard structure, which has a stable and solid front axle assembly and rear axle assembly, and a stable and reliable buffering structure is also provided on the skateboard to ensure the stability of the driving process.

### SUMMARY

The present invention provides an electric skateboard, which includes a main board body, a front axle assembly, a rear axle assembly, a moving device and an electric control device;
wherein, the main board body has a front end and a rear end, the front axle assembly is arranged at the front end, the rear axle assembly is arranged at the rear end, the electric control device is electrically connected with the front axle assembly and the rear axle assembly, and the moving device supports and moves the skateboard; and
wherein, the front axle assembly includes a front support component, and the front support component forms a rotatable connection with the main board body; and
wherein, the rear axle assembly includes a driving device, a rear support component and at least one buffering mechanism, wherein the main board body is rotatably connected to the rear support component, and the buffering mechanism is operatively connected to the main board body and the moving device, and provides buffering for a movement of the skateboard when the skateboard is in a moving state.

The present invention also provides an electric skateboard, which includes a main board body, a front axle assembly, a rear axle assembly, a moving device and an electric control device;
wherein, the main board body has a front end and a rear end, the front axle assembly is arranged at the front end, the rear axle assembly is arranged at the rear end, the electric control device is electrically connected with the front axle assembly and the rear axle assembly, and the moving device supports and moves the skateboard; and
wherein, the front axle assembly includes a front support component and at least one buffering mechanism, wherein the front support component is rotatably connected with the main board body, and the buffering mechanism is operatively connected to the main board body and the mobile device, and provides buffering for a movement of the skateboard when the skateboard is in a moving state; and
wherein, the rear axle assembly includes a driving device and a rear support component, and the main board body is rotatably connected to the rear support component.

The present invention also provides a buffering mechanism of an electric skateboard, which includes a support structure, a damper assembly and a restorer assembly, wherein the support structure includes at least one fixed support component and a movable support component; the fixed support component is fixedly connected with the damper assembly and the restorer assembly; the damper assembly is provided with a damper push rod and a damper shell which can slide on the damper push rod; and the restorer assembly includes a restorer fixing assembly and at least one elastic member; two ends of the elastic member are pressed against two ends of the restorer fixing component, the movable support component is operatively connected with the damper assembly and the restorer assembly, and the damper assembly further includes at least one damping adjusting device which is arranged on the damper shell and can change a damping size of the damper assembly.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic perspective view of a skateboard;

FIG. 2 is a schematic diagram of the overall explosion of the skateboard;

FIG. 3 is a schematic perspective view of the electronic control device;

FIG. 4 is a schematic perspective view of the control assembly;

FIG. 5 is a perspective view of the front axle assembly;

FIG. 6 is an explosion schematic diagram of the front axle assembly;

FIG. 7 is a schematic diagram of the rear explosion of the front axle assembly;

FIG. 8 is a schematic perspective view of the bridge arm;

FIG. 9 is an explosion schematic diagram of the buffering structure;

FIG. 10 is a schematic perspective view of the bridge support;

FIG. 11 is an explosion schematic diagram of the restorer assembly;

FIG. 12 is a schematic perspective view of the skateboard viewed from the rear;

FIG. 13 is a schematic perspective view of the rear axle assembly;

FIG. 14 is an explosion schematic diagram of the driving device;

FIG. 15 is a schematic perspective view of the driving device for removing the dust cover;

FIG. 16 is a schematic perspective view of the driving device viewed from the rear.

In the figures:

Main board body (100); Board surface (101); Antiskid member (102); Headlamp (103); Tail lamp (104); Front end (106); Rear end (107); Tire (110); Wheel hub (112); Electric control device (200); Sealing gasket (201); Battery armor (203); Battery compartment cover (205); Battery core (206); Battery circuit board (207); Battery inlet circuit (209); Battery discharge circuit (211); First light connection port (213); First light cable (215); BMS (216); Controller shell (240); First control circuit board (250); First control circuit component (251); Light control circuit board (260); Light control circuit component (261); Antenna assembly (265); Power switch (267); Charging port (269); First motor cable (271); Second motor cable (272); Tai lamp cable (273); Cable connector (274); Motor cable clamp (276); Front axle assembly (300); Front support component (305); Fixed support component (310); Movable support component (315); Front axle (316); Bridge arm (317); Damping push rod installation cavity (318); Support shaft installation cavity (319); Bridge support (320); Central shaft cavity (321); Support shaft hole (322); Central shaft hole (323); Damping hole (324); Support rotating shaft (325); Bridge damping block (326); Damper assembly (330); Damping adjusting device (331); Damper lower protective plate (333); Damper shell (335); Damper push rod (337); Damper slider (339); Damper clamp (340); Sliding cavity (341); Restorer assembly (360); Restorer fixing seat (362); Movable shaft block (364); Restorer adjusting nut (366); Central shaft sleeve (368); Central shaft connector (369); Restorer spring (370); Spring first base (372); First connecting shaft (373); Restoring rubber (374); Spring second base (375); Rear axle assembly (400); Driving device (410); Reinforcing rod (412); Rear axle (414); Motor (416); Driving substrate (418); Driving gear (420); Driven gear (422); Transmission belt (424); Dust cover (426).

### DESCRIPTION OF EMBODIMENTS

In the following, the technical scheme in the embodiment of the application will be clearly and completely described with reference to the drawings in the embodiment of the application. Obviously, the described embodiment is only a part of the embodiment of the application, but not the whole embodiment. Based on the embodiments in this application, all other embodiments obtained by those skilled in the art without creative labor belong to the protection scope of this application.

Reference to “an example” or “an embodiment” herein means that a particular feature, structure or characteristic described in connection with an embodiment or an embodiment can be included in at least one embodiment of this application. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

In this specification, for the sake of convenience, words and expressions indicating orientation or positional relationship such as “middle”, “upper”, “lower”, “front”, “rear”, “vertical”, “horizontal”, “top”, “inner” and “outer” are used to illustrate the positional relationship of constituent elements with reference to the attached drawings, only for the convenience of description. The positional relationship of the constituent elements is appropriately changed according to the direction of the described constituent elements. Therefore, it is not limited to the words and expressions described in the specification, and can be replaced appropriately according to the situation.

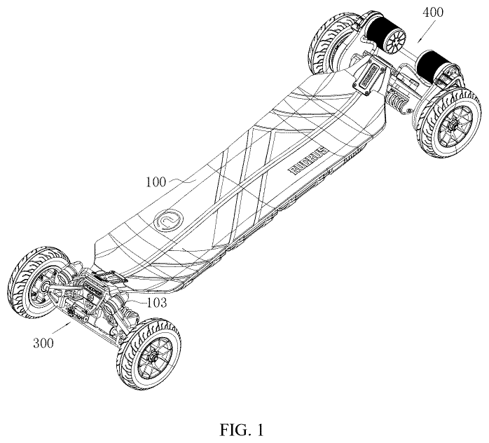

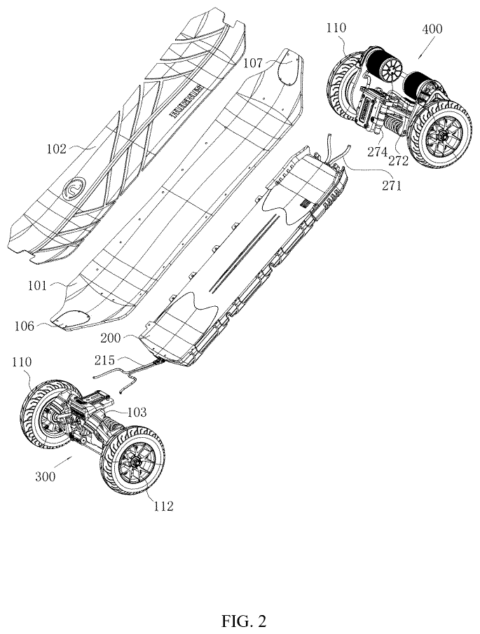

As shown in FIGS. 1 and 2, the present invention provides an electric skateboard, which includes a main board body 100, a front axle assembly 300 and a rear axle assembly 400, wherein the main board body 100 has a front end 106 and a rear end 107, and the front axle assembly 300 is arranged at the front end 106 and the rear axle assembly 400 is arranged at the rear end 107.

The skateboard also includes an electric control device 200 and a moving device arranged below the main board body 100, wherein the electric control device 200 is electrically connected with the front axle assembly 300 and the rear axle assembly 400, and the moving device supports and moves the skateboard.

The moving device can be a wheel, a mechanical foot, a crawler, etc. In this embodiment, the moving device includes a wheel hub 112 and a tire 110 fixed on the wheel hub 112. As the core component of the mobile device, the wheel hub 112 bears the heavy responsibility of bearing the tire 110 and the whole equipment, and the tire 110 is responsible for providing good road holding and stability during contact with the ground. The wheel hub 112 can be made of aluminum alloy, steel and other materials to meet different scenes and load requirements, but it is not limited thereto and can be any other materials that can meet the requirements. Tire 110 is the part where the mobile device contacts the ground, and its performance directly affects the running performance and stability of the equipment. The material of the tire 110 needs to have high strength and wear resistance to ensure a long service life. According to different terrain and load conditions, the tire 110 can adopt different tread patterns to provide the tire 110 with different performances such as good road holding, wear resistance and skid resistance. In practical application, according to different scenes and requirements, a suitable combination of wheel hub 112 and tire 110 can be selected to achieve efficient and stable mobility.

The skateboard also includes a headlamp 103, which is arranged at the front end 106 of the main board body 100 to improve the comfort and safety of users. The headlamp 103 adopts a LED light source, which has the advantages of high brightness, low energy consumption and long life.

In other embodiments, the headlamp 103 may also be a fluorescent lamp, a gas discharge lamp, or the like.

In another embodiment, the headlamp 103 is also equipped with an intelligent function, which can automatically adjust the brightness according to the ambient light, further improving the driving safety.

The skateboard further includes an electric control device 200 arranged at the bottom of the main board body 100, and a first light cable 215 is arranged at one end of the electric control device 200 near the front end 106, and the headlamp 103 is electrically connected with the first light cable 215.

The rear axle assembly 400 is provided with a driving device 410. In this embodiment, the driving device 410 is mainly driven by a motor.

In another embodiment, the driving device 410 can also be driven by a fuel engine, hybrid power or other new energy sources.

A motor cable is arranged at one end of the electronic control device 200 near the rear end of the main board body 100, and the motor cable connects the electronic control device 200 and the driving device 410. The motor cable includes a first motor cable 271 and a second motor cable 272, one end of the first motor cable 271 is connected to the electronic control device 200, and one end of the second motor cable 272 is connected to the driving device 410. The first motor cable 271 and the second motor cable 272 are electrically connected through a cable connector 274.

The main board body 100 includes a board surface 101 and at least one anti-skid member 102 arranged on the board surface 101. In this embodiment, the anti-skid member 102 is anti-skid sandpaper, which has a rough surface and can increase the friction force of a user stepping on a skateboard. The anti-skid member 102 is composed of a plurality of anti-skid sandpapers, which not only enhances the personality of the skateboard, but also avoids the problem that the anti-skid member 102 needs to be replaced as a whole after being damaged, and the damaged anti-skid sandpaper can be replaced separately.

In another embodiment, the anti-slip member 102 may be made of a rubber material. Rubber has good elasticity and wear resistance, which can effectively increase the friction on the surface of skateboard and play a role in anti-skid.

In another embodiment, some special coating materials can also be used to make the anti-skid member 102. They can increase the friction and improve the anti-skid performance by forming an anti-skid coating on the surface. These alternative materials can provide anti-skid effect similar to sandpaper, but also have their own unique characteristics and applicable scenarios. Therefore, the choice of anti-skid materials should be comprehensively considered according to the actual needs and conditions.

In another embodiment, the front axle assembly 300 is also provided with at least one anti-collision bar. When a vehicle collides, the anti-collision bar can effectively absorb the impact force and reduce the impact on the car body and other components. When a vehicle collides, the bumper often bears the impact force first, thus protecting other parts of the vehicle from damage. In this way, the maintenance cost of the skateboard has been effectively controlled.

In this embodiment, the skateboard is controlled by a remote controller. In another embodiment, the skateboard can also be controlled by somatosensory induction, resistance induction and mechanical buttons on the board.

In another embodiment, the tire 110 is also provided with a fender, which can improve the comfort of using on muddy road sections.

In another embodiment, the main board body 100 is also provided with a detachable pull rod to improve the operability of the skateboard and lower the operating threshold.

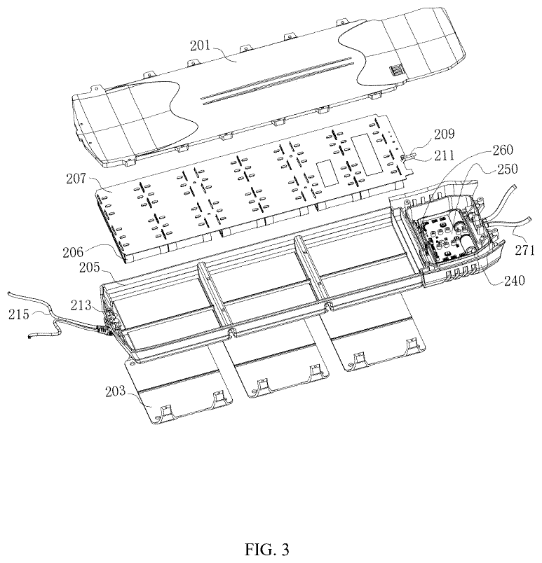

As shown in FIGS. 2 and 3, the skateboard also includes an electric control device 200 arranged at the bottom of the main board body 100, which includes a battery assembly and a control assembly. The battery assembly includes a sealing gasket 201 and a battery compartment cover 205 fixed at the bottom of the main board body 100. The battery compartment cover 205 is covered with at least one battery armor 203, which can protect the battery compartment cover 205. In this example, there are three battery armors 203. The material and structural form of battery armor 203 can be selected and designed according to different application scenarios and requirements, including the use of metals, ceramics, composite armor, etc.

In another embodiment, the battery armor 203 is made of lightweight materials such as aluminum alloy and titanium alloy, which can provide good impact resistance without increasing the load.

In another embodiment, the battery armor 203 is made of a composite armor, which is composed of multiple materials. Through the combination and optimization of different materials, the protection ability can be improved.

A battery circuit board 207 and a battery core 206 are arranged in the battery compartment cover 205, the battery core 206 is electrically connected with the battery circuit board 207, and the battery core 206 is fixed on the battery circuit board 207 through a battery bracket, and a BMS (battery management system) is arranged on the battery circuit board 207, and the BMS 216 is electrically connected with the battery circuit board 207. BMS 216 is responsible for monitoring the working parameters of battery core 206 in real time to ensure that the battery operates in the best working condition.

BMS 216 is arranged on the battery circuit board 207, which further improves the

safety of the battery. BMS 216 can monitor the working state of battery core 206 in real time, and take immediate measures to protect it when abnormal conditions are found. For example, when the temperature of the battery core 206 is too high, the BMS 216 will start the cooling system to reduce the temperature of the battery core 206 and prevent the battery core 206 from being damaged by overheating. In addition, BMS 216 can effectively prevent overcharge and overdischarge of battery core 206 and ensure the safety of battery core 206 during use.

The battery circuit board 207 is provided with a battery inlet circuit 209 and a battery discharge circuit 211. The battery core 206 is electrically connected with the battery circuit board 207, the battery core 206 is electrically connected with the battery inlet circuit 209 and the battery discharge circuit 211, and one end of the battery compartment cover 205 near the front end 106 is provided with a first light connection port 213 which is connected with a first light cable 215, and the battery core 206 is connected with the first light cable 215 and the first light connection port 213.

In this embodiment, the battery inlet circuit 209 adopts the 18AWG specification, and the battery discharge circuit 211 adopts the 13AWG specification, but it is not limited thereto, and it can also be any other specifications that meet the requirements.

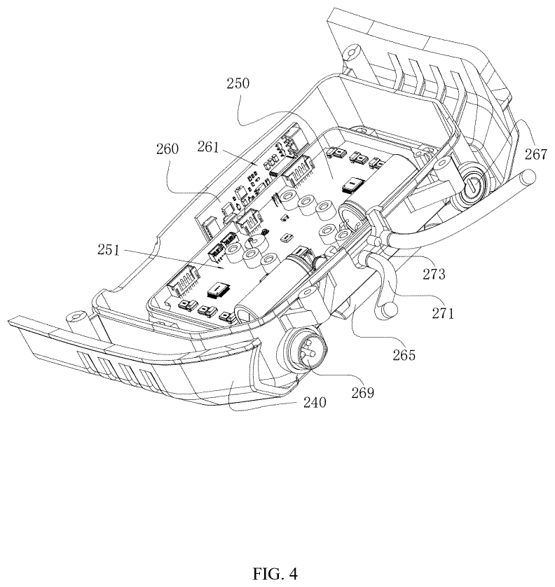

As shown in FIGS. 3 and 4, the control assembly includes a controller shell 240, a light control circuit component and a first control circuit component, wherein the light control circuit component and the first control circuit component are arranged in the controller shell 240; the battery core 206 is electrically connected with the light control circuit component and the first control circuit component; one end of the battery compartment cover 205 far from the front end 106 is connected with the control assembly; and the battery inlet circuit 209 and the battery inlet circuit 209 are respectively electrically connected with the control assembly.

Wherein, the first control circuit component includes a first control circuit board 250 and a first control circuit component 251 disposed on the first control circuit board 250. The first control circuit component 251 includes a motor controller, a driver, a sensor, an encoder, and the like. These components are responsible for receiving and processing signals from the system, and controlling parameters such as starting, stopping, direction and speed of the motor according to instructions, so as to realize accurate movement and position control of the motor.

Wherein, the light control circuit component includes a light control circuit board 260 and a light control circuit component 261 arranged on the light control circuit board 260. The light control circuit component 261 includes a light controller, a sensor, a dimmer, a relay and the like. These components are responsible for receiving and processing signals from the system, and controlling the switch, brightness, color temperature and other parameters of the light according to instructions to meet the needs of users.

One end of the control assembly near the rear end 107 of the main board body 100 is provided with an antenna assembly 265, a power switch 267, a charging port 269, a motor cable and a tail lamp cable 273.

The antenna assembly 265 is electrically connected with the control assembly, the power switch 267 is electrically connected with the control assembly, the charging port 269 is electrically connected with the control assembly, the motor cable is electrically connected with the control assembly, and the tai lamp cable 273 is electrically connected with the control assembly.

In another embodiment, the control assembly also includes an adjustable speed limit system to avoid the danger caused by the skateboard's speed increasing too fast when passing through the downhill section.

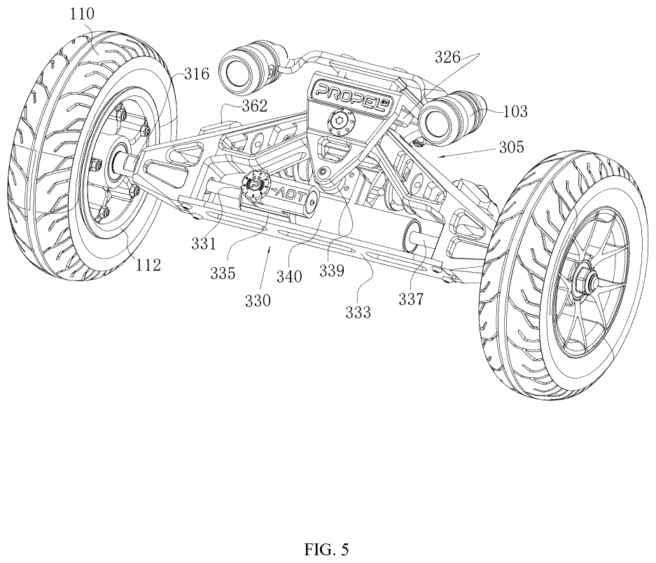

As shown in FIGS. 1 and 5, the front axle assembly 300 includes a front support component 305 and at least one buffering mechanism, which includes a support structure and a front axle 316, and the buffering mechanism includes a damper assembly 330 and a restorer assembly 360. The damper assembly 330 also includes at least one damper adjusting device 331 arranged on a damper shell 335, and the damper adjusting device 331 can change the damping of the damper assembly 330.

In this embodiment, there are two buffering devices, which are respectively arranged on the front axle assembly 300 and the rear axle assembly 400. The front axle assembly 300 and the rear axle assembly 400 are rotatably connected to the main board body 100. When the skateboard is in motion, the buffering mechanism provides buffering for the movement of the skateboard through the front axle assembly 300 and the rear axle assembly 400.

In another embodiment, only one buffering device can be provided, only on the front axle assembly 300. The front axle assembly 300 and the rear axle assembly 400 are rotatably connected to the main board body 100. When the skateboard is in motion, the buffering mechanism provides buffering for the movement of the skateboard through the front axle assembly 300.

In another embodiment, only one buffering device can be provided, only on the rear axle assembly 400. The front axle assembly 300 and the rear axle assembly 400 are rotatably connected to the main board body 100. When the skateboard is in motion, the buffering mechanism provides buffering for the movement of the skateboard through the rear axle assembly 400.

In another embodiment, only one buffering device can be provided, and the buffering device is simultaneously connected with the front axle assembly 300 and the rear axle assembly 400, the front axle assembly 300 and the rear axle assembly 400 are rotatably connected to the main board body 100. When the skateboard is in motion, the buffering mechanism provides buffering for the movement of the skateboard through the front axle assembly 300 and the rear axle assembly 400.

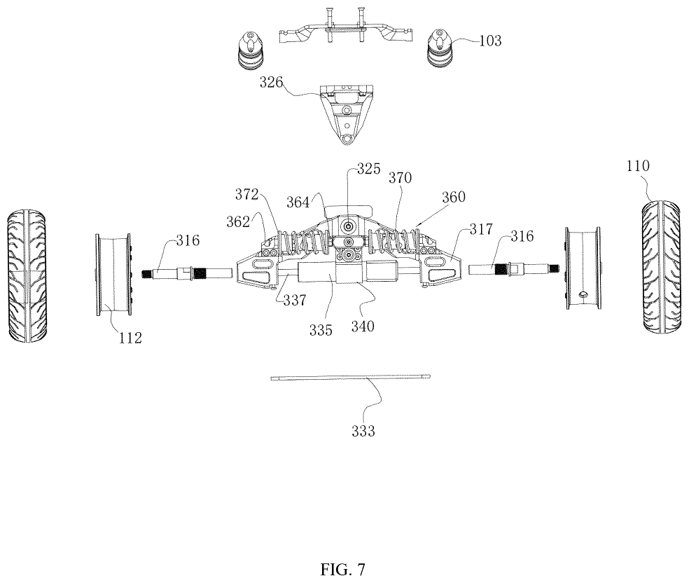

As shown in FIG. 1, FIG. 5 to FIG. 7, the support structure includes a fixed support component 310 and a movable support component 315. The fixed support component 310 fixedly connects the damper assembly 330 and the restorer assembly 360, and the damper assembly 330 has a damper push rod 337 and a damper shell 335 that can slide on the damper push rod 337.

The restorer assembly 360 includes a restorer fixing component and at least one elastic member, two ends of which are pressed against two ends of the restorer fixing component, and the movable support component 315 operatively connects the damper assembly 330 and the restorer assembly 360.

The front axle 316 is arranged on the bridge arm 317, and the wheel hub 112 is rotatably connected with the front axle 316.

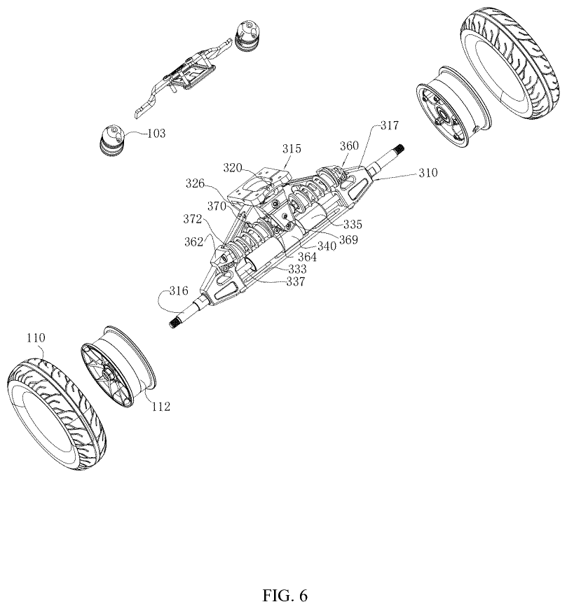

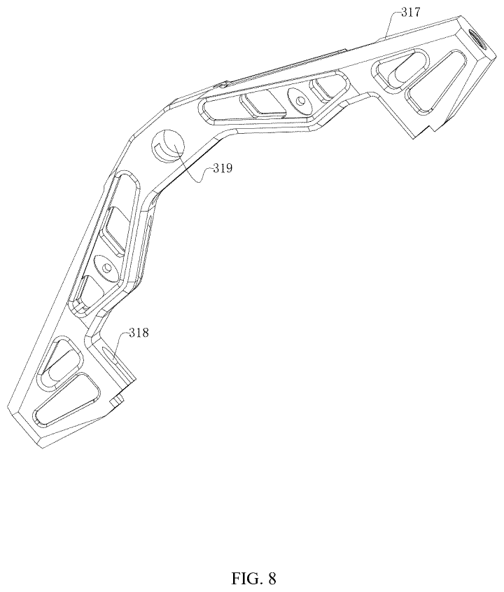

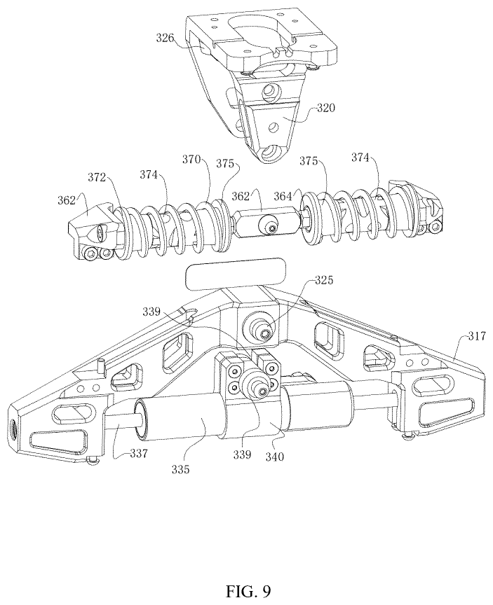

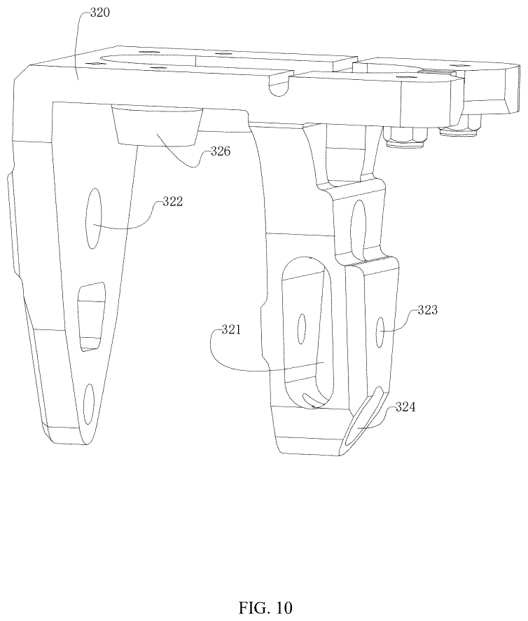

As shown in FIGS. 6 and 8, the fixed support component 310 includes a bridge arm 317, which has a damping push rod installation cavity 318 and a support shaft installation cavity 319. The damper push rod 337 is mounted in the damping push rod installation cavity 318, and a damper clamp 340 is arranged on the damper shell 335. The damper clamp 340 has a sliding cavity 341, and a damper slider 339 is slidably arranged in the sliding cavity 341, and the damper slider 339 is rotatably connected in the damping hole 324. A damper lower protective plate 333 is arranged below the damper push rod 337, and the damper lower protective plate 333 can prevent damage caused by objects such as stones on the ground. As shown in FIG. 6, FIG. 8 to FIG. 10, the movable support component 315

includes a bridge support 320 having a central shaft cavity 321, a support shaft hole 322, a central shaft hole 323 and a damping hole 324. A support rotating shaft 325 is rotatably arranged in the support shaft installation cavity 319, and the support rotating shaft 325 is rotatably connected with the support shaft hole 322. At least one bridge damping block 326 is fixed on the bridge support 320. When the bridge support 320 reaches the maximum swing amplitude, the bridge damping block 326 will contact the bridge arm 317, and the bridge damping block 326 can slow down the impact during movement, ensuring safety and comfort.

In this embodiment, the bridge damping block 326 is made of a rubber material, which has good elasticity and damping performance, low cost, easy processing and convenient use.

In another embodiment, the bridge damping block 326 adopts a steel spring, and the steel spring damping block has the advantages of good damping effect, good durability and good fatigue resistance.

In another embodiment, the bridge damping block 326 is made of a viscoelastic material: viscoelastic material is a polymer material with good elasticity and damping performance, good damping effect and good durability.

In another embodiment, the composite material used in the bridge damping block 326 is a material composed of two or more materials, which can be combined according to different requirements to achieve the best damping effect.

To sum up, the bridge damping block 326 can be made of rubber, composite material, steel spring and viscoelastic material. In practical application, appropriate materials and structures should be selected according to specific conditions to achieve the best vibration reduction effect.

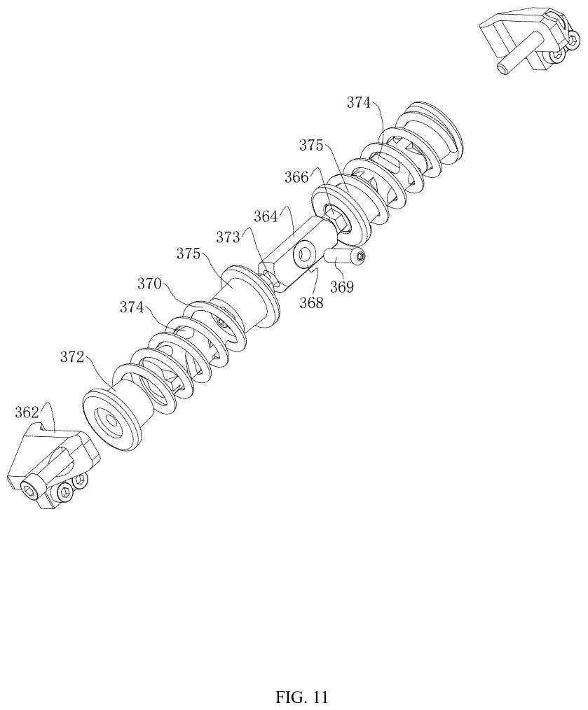

As shown in FIG. 6 and FIG. 11, the reducer assembly 360 includes at least one movable central shaft block 364 with a central shaft sleeve 368, and a central shaft connector 369 rotatably connected with the central shaft hole 323 is arranged in the central shaft sleeve 368, and the central shaft connector 369 is connected with the movable central shaft block 364 and the bridge support 320, and the movable central shaft block 364 is arranged in the central shaft cavity. In this embodiment, the central shaft sleeve 368 is made of graphite. Graphite material has good wear resistance and vibration resistance, and the manufacturing process is relatively simple, which can reduce the production cost.

In another embodiment, the central shaft sleeve 368 may be made of ceramics. Ceramic materials have high hardness, high strength and excellent wear resistance, so ceramic bushings show good performance in many mechanical equipment with high temperature, high load and corrosive environment.

In another embodiment, the central shaft sleeve 368 may be made of a metal matrix composite material. This kind of material combines the high strength of metal and the high wear resistance of composite materials, and has excellent properties.

The restorer fixing component includes a spring first base 372 and a spring second base 375 which are oppositely arranged; the elastic member includes a restorer spring 370 and a restoring rubber 374 which are arranged between the spring first base 372 and the spring second base 375; both ends of the spring second base 375 are respectively connected with the restoring rubber 374 and the movable axle block 364; and the restorer fixing component also includes a restorer fixing seat arranged on the bridge arm 317.

The restorer assembly 360 also includes a first connecting shaft 373 arranged in the first spring base 372. One end of the first connecting shaft 373 far from the first spring base 372 is arranged in the movable central shaft block 364, and a restorer adjusting nut 366 is operatively arranged on the first connecting shaft 373, which can change the elastic force of the elastic member.

As shown in FIG. 1, FIG. 6 to FIG. 11, when the buffering mechanism is in a normal state, the support shaft hole 322, the central shaft hole 323 and the damping hole 324 of the bridge bearing 320 are approximately perpendicular to the damper assembly 330, the elastic forces of the two restorer springs 370 are approximately equal, and the position of the damper shell 335 on the damper push rod 337 is approximately centered. When the skateboard turns or swings, the main board body 100 will tilt to either side. The restorer spring 370 of the restorer will be subjected to reaction force, and the restorer spring 370 in the opposite direction inclined to the main board body 100 will be compressed. At the same time, the bridge support 320 pushes the damper shell 335 to move in the opposite direction inclined to the main board body 100 through the damper slider 339 to generate damping force in the opposite direction, and the force generated when the main board body 100 is inclined is balanced by the reaction force and damping force of the spring, thus ensuring the stability during movement.

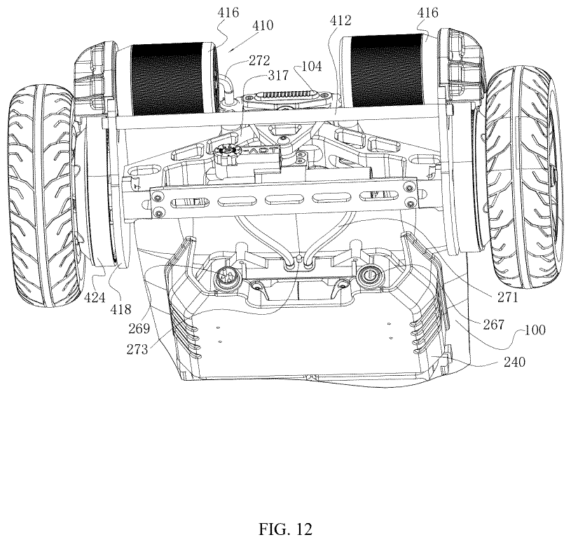

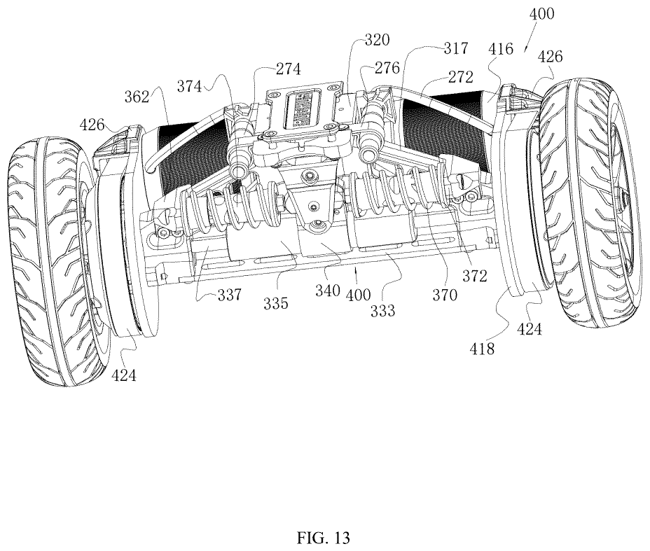

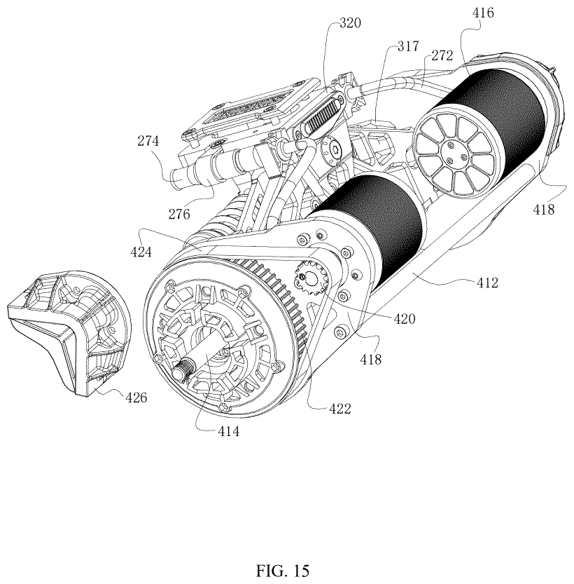

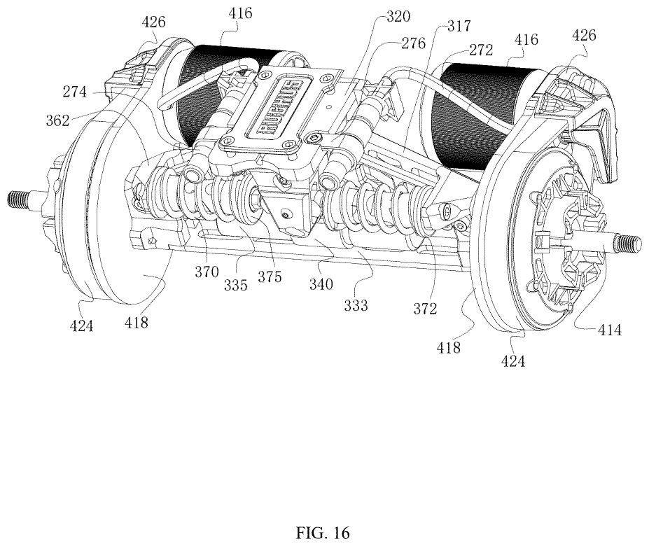

As shown in FIGS. 12 to 16, the rear axle assembly 400 includes a driving device 410, a rear support component and at least one buffering mechanism. The rear support component includes a support structure, a rear axle 414 and a reinforcing rod 412. The buffering mechanism includes a damper assembly 330 and a restorer assembly 360. The reinforcing rod 412 helps to stabilize the driving device 410, and can reduce the damage of the motor 416 to some extent.

Wherein, the main board body 100 is rotatably connected to the rear support component, and the buffering mechanism is operatively connected to the main board body 100 and the mobile device, and provides buffering for the movement of the skateboard when the skateboard is in a moving state.

The skateboard also has a tai lamp 104, which is arranged at the rear end of the main board body 100, and is electrically connected with a tai lamp cable 273.

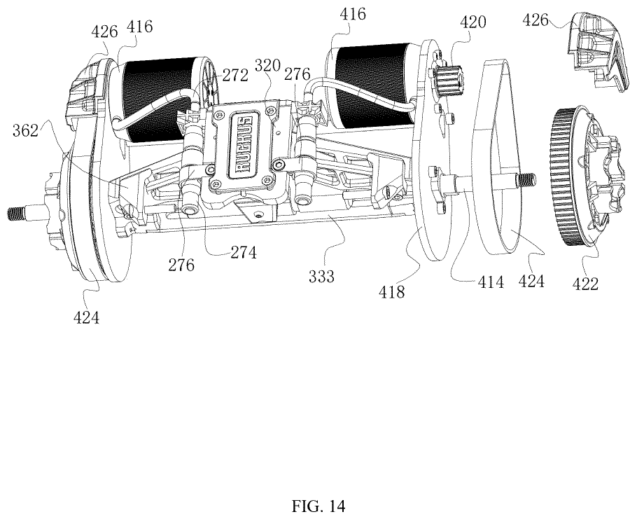

As shown in FIGS. 14 to 16, the driving device 410 includes a driving substrate 418 and a motor 416 fixed on the driving substrate 418. The motor 416 has an output end, and a driving gear 420 is provided on the output end.

Wherein, the driving device 410 further includes a driven gear 422, a transmission belt 424 and a dust cover 426, wherein the driven gear 422 is rotatably connected to the driving substrate 418; the transmission belt 424 movably connects the driven gear 422 and the driving gear 420; and the dust cover 426 is installed on the driving substrate 418 to cover the driving gear 420. The dust cover 426 can protect the driving gear 420 and prevent the driving gear 420 from being damaged by external dust, gravel, hair and other fine objects.

Wherein, the driven gear 422 is provided with a wheel fixing groove, and the wheel hub 112 is provided with a wheel fixing plate matched with the wheel fixing groove, and the driven gear 422 drives the wheel hub 112.

Wherein, the driving device 410 further includes a motor cable clamp 276, which is fixed on the bridge support 320, and one end of the second motor cable 272 is connected to the cable connector 274, and the motor cable clamp 276 fixes the cable connector 274. In this embodiment, the skateboard has two motors 416 and two driving substrates

418, which are respectively arranged at the left and right ends of the rear axle assembly 400. This design enables the skateboard to obtain stronger power output and more stable driving performance during driving. With the motors 416 and the driving base plates 418 distributed on the left and right sides, the skateboard can achieve an efficient and balanced driving effect and adapt to various complicated road conditions.

In another embodiment, the skateboard has a motor 416, which is arranged in the middle of the rear axle assembly 400 and has two output shafts. This motor 416 is cleverly arranged in the middle of the rear axle assembly 400, which can ensure that the center of gravity of the motor 416 coincides with that of the skateboard, thus improving the driving stability.

In another embodiment, the skateboard has a motor 416 with only one output end, but the single output end of the motor 416 is converted into two independent power output channels through clever gear design to output power for the wheel hubs 112 on both sides. In this way, the skateboard can still maintain good dynamic performance and stability during driving.

To sum up, through the different designs of the motor 416 of the skateboard, the efficient, stable and low-cost driving solutions in different needs and scenarios have been achieved. These embodiments show the diversity and flexibility of the skateboard drive system design, and provide more choices for consumers. At the same time, we will continue to study more innovative design of skateboard drive system to meet market demand and enhance user experience.

The principles and modes of operation of the present invention have been described in various embodiments thereof. It should be noted, however, that the present invention may be practiced otherwise than as specifically shown and described without departing from its scope.

What is claimed is:

1. An electric skateboard, comprising a main board body, a front axle assembly, a rear axle assembly, a moving device and an electric control device; central
wherein, said main board body has a front end and a rear end, said front axle assembly is arranged at said front end, said rear axle assembly is arranged at said rear end, said electric control device is electrically connected with said front axle assembly and said rear axle assembly, and said moving device supports and moves said skateboard; and
wherein, said front axle assembly comprises a front support component, and said front support component forms a rotatable connection with said main board body; and
wherein, said rear axle assembly comprises a driving device, a rear support component and at least one buffering mechanism, wherein said main board body is rotatably connected to said rear support component, and said buffering mechanism is operatively connected to said main board body and said moving device, and provides buffering for a movement of said skateboard when said skateboard is in a moving state.

2. The electric skateboard according to claim 1, wherein said electric control device is arranged at a bottom of said main board body, and comprises a battery assembly, wherein said battery assembly comprises a sealing gasket and a battery compartment cover fixed at the bottom of said main board body; said battery compartment cover is covered with at least one battery armor, and a battery circuit board and a battery core are arranged in said battery compartment cover; and
wherein, said battery circuit board is provided with a battery inlet circuit and a battery discharge circuit, and said battery core is electrically connected with said battery circuit board.

3. The electric skateboard according to claim 1, wherein said rear support component comprises a support structure, a rear axle and a reinforcing rod, and said buffering mechanism comprises a damper assembly and a restorer assembly; and
wherein, said support structure comprises at least one fixed support component and a movable support component, said fixed support component is fixedly connected with said damper assembly and said restorer assembly, said damper assembly is provided with a damper push rod and a damper shell which can slide on said damper push rod; said restorer assembly comprises a restorer fixing component and at least one elastic member, and two ends of said elastic member are pressed against two ends of said restorer fixing component; said movable support component is operatively connected with said damper assembly and said restorer assembly; and said damper assembly further comprises at least one damping adjusting device, which is arranged on said damper shell and can change a damping size of said damper assembly.

4. The electric skateboard according to claim 3, wherein said movable support component comprises a bridge support, and said bridge support is provided with a central shaft cavity, a support shaft hole, a central shaft hole and a damping hole; and
wherein, said fixed support component comprises a bridge arm, said bridge arm is provided with a damping push rod installation cavity and a support shaft installation cavity, said damper push rod is installed in said damping push rod installation cavity, a damper clamp is arranged on said damper shell, at least one sliding cavity is arranged on said damper clamp, at least one damper slider is arranged in said sliding cavity in a sliding way up and down, and said damper slider is rotatably connected in said damping hole; and
wherein, a support rotating shaft is rotatably arranged in said support shaft installation cavity, and said support rotating shaft is rotatably connected with said support shaft hole; and
wherein at least one bridge damping block is fixed on said bridge support.

5. The electric skateboard according to claim 3, wherein said restorer assembly comprises at least one movable central shaft block, and said movable central shaft block is provided with a central shaft sleeve, and a central shaft connector is rotatably arranged in said central shaft sleeve, and said central shaft connector is rotatably connected with said movable support component; and
said restorer fixing component comprises a spring first base and a spring second base which are oppositely arranged; said elastic member comprises a restorer spring and a restoring rubber arranged between said spring first base and said spring second base; two ends of said spring second base are respectively connected with said restoring rubber and said movable central shaft block; said restorer fixing component further comprises a restorer fixing seat arranged on said fixed support component; and
said restorer fixing seat is connected with said spring first base.

6. The electric skateboard according to claim 5, wherein said restorer assembly further comprises a first connecting shaft arranged in said spring first base, and one end of said first connecting shaft far from said spring first base is arranged in said movable central shaft block, and a restorer adjusting nut is operatively arranged on said first connecting shaft, and said restorer adjusting nut can change an elastic force of said elastic member.

7. The electric skateboard according to claim 1, wherein said moving device comprises a wheel hub and a tire fixed on said wheel hub; and
said driving device comprises a driving substrate and a motor fixed on said driving substrate, wherein said motor has at least one output end, and a driving gear is arranged on said output end; and
wherein, said driving device further comprises a driven gear, a transmission belt and a dust cover, wherein said driven gear is rotatably connected to said driving substrate, said transmission belt is movably connected with said driven gear and said driving gear, and said dust cover is installed on said driving substrate to cover said driving gear; and
wherein said driven gear is provided with a wheel fixing groove, said wheel hub is provided with a wheel fixing plate matched with said wheel fixing groove, and said driven gear drives said wheel hub; and
wherein, said driving device further comprises a motor cable clamp, and said motor cable clamp is fixed on said rear axle assembly.

8. The electric skateboard according to claim 1, wherein said electric control device comprises a control assembly, which comprises a controller shell, a light control circuit component and a first control circuit component, wherein said light control circuit component and said first control circuit component are arranged in said controller shell; said battery core is electrically connected with said light control circuit component and said first control circuit component; one end of said battery compartment cover far from said front end is connected with said control assembly;
and said battery inlet circuit and said battery discharge circuit are respectively electrically connected with said control assembly.

9. An electric skateboard, comprising a main board body, a front axle assembly, a rear axle assembly, a moving device and an electric control device;
wherein, said main board body has a front end and a rear end, said front axle assembly is arranged at said front end, said rear axle assembly is arranged at said rear end, said electric control device is electrically connected with said front axle assembly and said rear axle assembly, and said moving device supports and moves said skateboard; and
wherein, said front axle assembly comprises a front support component and at least one buffering mechanism, wherein said front support component is rotatably connected with said main board body, and said buffering mechanism is operatively connected to said main board body and said mobile device, and provides buffering for a movement of said skateboard when said skateboard is in a moving state; and
wherein, said rear axle assembly comprises a driving device and a rear support component, and said main board body is rotatably connected to said rear support component.

10. The electric skateboard according to claim 9, wherein said electric control device is arranged at a bottom of said main board body, and comprises a battery assembly, wherein said battery assembly is fixed on a sealing gasket and a battery compartment cover at the bottom of said main board body; said battery compartment cover is covered with at least one battery armor, and a battery circuit board and a battery core are arranged in said battery compartment cover; and
wherein, said battery circuit board is provided with a battery inlet circuit and a battery discharge circuit, and said battery core is electrically connected with said battery circuit board.

11. The electric skateboard according to claim 9, wherein said front support component comprises a support structure and a front axle, and said buffering mechanism comprises a damper assembly and a restorer assembly; and
wherein, said support structure comprises at least one fixed support component and a movable support component, said fixed support component is fixedly connected with said damper assembly and said restorer assembly, said damper assembly is provided with a damper push rod and a damper shell which can slide on said damper push rod; said restorer assembly comprises a restorer fixing component and at least one elastic member, and two ends of said elastic member are pressed against two ends of said restorer fixing component; said movable support component is operatively connected with said damper assembly and said restorer assembly; said damper assembly also comprises at least one damping adjusting device, which is arranged on said damper shell and can change a damping size of said damper assembly.

12. The electric skateboard according to claim 11, wherein said movable support component comprises a bridge support, and said bridge support is provided with a center shaft cavity, a support shaft hole, a center shaft hole and a damping hole; and
wherein, said fixed support component comprises a bridge arm, and said bridge arm is provided with a damping push rod installation cavity and a support shaft installation cavity; said damper push rod is installed in said damping push rod installation cavity, and a damper clamp is arranged on said damper shell; at least one sliding cavity is arranged on said damper clamp, a damper slider is arranged in said sliding cavity in a sliding way up and down, and said damper slider is rotatably connected in said damping hole; and
wherein, a support rotating shaft is rotatably arranged in said support shaft installation cavity, and said support rotating shaft is rotatably connected with said support shaft hole; and
wherein at least one bridge damping block is fixed on said bridge support.

13. The electric skateboard according to claim 11, wherein said restorer assembly comprises at least one movable central shaft block, and said movable central shaft block is provided with a central shaft sleeve, and a central shaft connector is rotatably arranged in said central shaft sleeve, and said central shaft connector is rotatably connected with said movable support component; and
said restorer fixing component comprises a spring first base and a spring second base which are oppositely arranged; said elastic member comprises a restorer spring and a restoring rubber arranged between said spring first base and said spring second base; two ends of said spring second base are respectively connected with said restoring rubber and said movable central shaft block; said restorer fixing component further comprises a restorer fixing seat arranged on said fixed support component; and
said restorer fixing seat is connected with said spring first base.

14. The electric skateboard according to claim 13, wherein said restorer assembly further comprises a first connecting shaft arranged in said spring first base, one end of said first connecting shaft far away from said spring first base is arranged in said movable shaft block, and a restorer adjusting nut is operatively arranged on said first connecting shaft, and said restorer adjusting nut can change an elastic force of said elastic member; and
wherein, said damper assembly further comprises at least one damping adjusting device which is arranged on said damper shell and can change a damping size of said damper assembly.

15. The electric skateboard according to claim 9, wherein said moving device comprises a wheel hub and a tire fixed on said wheel hub, said front axle is arranged on said bridge arm, and said wheel hub is rotatably connected with said front axle; and
said driving device comprises a driving substrate and a motor fixed on said driving substrate, wherein said motor has at least one output end, and a driving gear is arranged on said output end; and
wherein, said driving device further comprises a driven gear, a transmission belt and a dust cover, wherein said driven gear is rotatably connected to said driving substrate, said transmission belt is movably connected with said driven gear and said driving gear, and said dust cover is installed on said driving substrate to cover said driving gear; and
wherein said driven gear is provided with a wheel fixing groove, said wheel hub is provided with a wheel fixing plate matched with said wheel fixing groove, and said driven gear drives said wheel hub; and
wherein, said driving device further comprises a motor cable clamp, and said motor cable clamp is fixed on said rear axle assembly.

16. The electric skateboard according to claim 9, wherein said electric control device comprises a control assembly, which comprises a controller shell, a light control circuit component and a first control circuit component, wherein said light control circuit component and said first control circuit component are arranged in said controller shell; said battery core is electrically connected with said light control circuit component and said first control circuit component; one end of said battery compartment cover far from said front end is connected with said control assembly;
and said battery inlet circuit and said battery discharge circuit are respectively electrically connected with said control assembly

17. A buffering mechanism for an electric skateboard, comprising a support structure, a damper assembly and a restorer assembly, wherein said support structure comprises at least one fixed support component and a movable support component;
said fixed support component is fixedly connected with said damper assembly and said restorer assembly; said damper assembly is provided with a damper push rod and a damper shell which can slide on said damper push rod; and said restorer assembly comprises a restorer fixing assembly and at least one elastic member; two ends of said elastic member are pressed against two ends of said restorer fixing component, said movable support component is operatively connected with said damper assembly and said restorer assembly, and said damper assembly further comprises at least one damping adjusting device which is arranged on said damper shell and can change a damping size of said damper assembly.

18. The buffering mechanism for an electric skateboard according to claim 17, wherein said movable support component comprises a bridge support, and said bridge support is provided with a central shaft cavity, a support shaft hole, a central shaft hole and a damping hole; and
wherein, said fixed support component comprises a bridge arm, said bridge arm is provided with a damping push rod installation cavity and a support shaft installation cavity; said damper push rod is arranged in said damping push rod installation cavity, and a damper clamp is arranged on said damper shell; at least one sliding cavity is arranged on said damper clamp, a damper slider is arranged in said sliding cavity in a sliding way up and down, and said damper slider is rotatably connected in said damping hole; and
wherein at least one bridge damping block is fixed on said bridge support; and
wherein, a support rotating shaft is rotatably arranged in said support shaft installation cavity, and said support rotating shaft is rotatably connected with said support shaft hole.

19. The buffering mechanism of said electric skateboard according to claim 17, wherein said restorer assembly comprises at least one movable central shaft block, and said movable central shaft block is provided with a central shaft sleeve, a central shaft connector is rotatably arranged in said central shaft sleeve, and said central shaft connector is rotatably connected with said central shaft hole, and said movable central shaft block is arranged in said central shaft cavity; and
said restorer fixing component comprises a spring first base and a spring second base which are oppositely arranged, and said elastic member comprises a restorer spring and a restoring rubber arranged between said spring first base and said spring second base; two ends of said spring second base are respectively connected with said restoring rubber and said movable central shaft block; said restorer fixing component further comprises a restorer fixing seat arranged on said bridge arm, and said restorer fixing seat is connected with said spring first base.

20. The buffering mechanism for an electric skateboard according to claim 19, wherein said restorer assembly further comprises a first connecting shaft arranged in said spring first base, and one end of said first connecting shaft far away from said spring first base is arranged in said movable shaft block; and a restorer adjusting nut is operatively arranged on said first connecting shaft, and said restorer adjusting nut can change an elastic force of said elastic member.
